(19) United States
(12) Patent Application Publication
(10) Pub. No.: US 2009/0053364 A1
(43) Pub. Date: Feb. 26, 2009

(54) LOW-INGREDIENT MEAT PRODUCTS AND METHOD FOR THEIR PREPARATION

(75) Inventors: Raija Lantto, Klaukkala (FI); Karin Autio, Espoo (FI); Kristiina Kruus, Espoo (FI); Johanna Buchert, Vtt (FI)

Correspondence Address: YOUNG & THOMPSON, 209 Madison Street, Suite 500, ALEXANDRIA, VA, 22314, US

(73) Assignee: VALTION TEKNILLINEN, Espoo (FI)

(21) Appl. No.: 12/279,057

(22) PCT Filed: Feb. 13, 2007
(86) PCT No.: PCT/FI2007/050077

§ 371 Date: Sep. 25, 2008

(30) Foreign Application Priority Data
Feb. 14, 2006 (FI) 20065109

(51) Int. Cl. A23L 1/317

(52) U.S. Cl. 426/59; 426/61

(57) ABSTRACT

Low-ingredient meat products, which contain a reduced amount of salt, phosphate and/or meat, generally have poor texture and water-binding properties. The texture and water binding of such a product may be significantly improved with tyrosinase, which is a protein cross-linking enzyme. The invention is directed to a method of preparing a low-ingredient meat product by adding tyrosinase, and to a low-ingredient meat product modified by tyrosinase.

### FIELD OF THE INVENTION

The invention relates to a method of preparing a low-ingredient meat product. More precisely the invention relates to a method of modifying the texture and/or water-binding properties of a low-ingredient meat product by adding a particular enzyme. The invention also relates to the modified low-ingredient meat product, as well as to the use of said enzyme in modifying the texture and/or water-binding properties of a low-ingredient meat product. The low-ingredient meat product has a low content of salt, phosphate and/or meat.

### BACKGROUND OF THE INVENTION

Meat and meat products constitute an essential nutritional source in the human diet. Meat is an excellent protein source, but in addition meat products usually comprise various amounts of fat, salt, phosphate, etc. Thus meat consumption may also be related to a number of diseases, such as cardiovascular disease, hypertension and obesity due to e.g. high salt and fat content, and therefore there is a continuous demand for healthier meat products.

Addition of sodium chloride (NaCl) and phosphates is normal practice in the meat industry to improve technological and sensory properties of the meat products. However, today consumer attitudes demand reduction of both salt and other chemical additives from meat products. The demand to reduce salt, i.e. NaCl, is mainly due to its role in the development of hypertension in Na-sensitive individuals. However, salt reduction is seldom straightforward, because apart from flavour and preservation, NaCl improves water holding and texture. Reducing salt leads to weakening of texture and increase in weight loss. In meat processing, phosphates are widely used to promote water binding and reduce cooking loss. Phosphates are added to compensate for the negative effect of low salt levels, which by definition is acceptable. However, the tendency of phosphates to reduce the amount of Ca and Mg in the human body causing modification in bones has created a need to reduce also the amount of phosphates. The same kind of problems with poor water holding and texture associated with reduced salt and phosphate products also arise when the meat or fat content is lowered in order to obtain a low-energy meat product.

Jimenez-Colmenero et al. (2001) have reviewed strategies for obtaining healthier meat and meat products by e.g. lowering energy and sodium content. The most widely used way to reduce the energy content is to reduce the fat content, whereas the sodium content may be reduced by replacing NaCl with potassium and magnesium salts and/or phosphates. The texture of the low-salt product may be improved e.g. by adding calcium alginate or transglutaminase. Jimenez-Colmenero (1996) reviews technologies for developing low-energy meat products. The methods can be divided into three groups; addition of non-meat ingredients, selection of meat ingredients, and adaptation of manufacturing processes. The non-meat ingredients may be non-meat proteins, vegetable oils, carbohydrates, or synthetic products, or simply water. Using lean meat in the meat product manufacture results in a lower energy content, but simultaneous reduction of fat decreases the perceived saltiness and characteristic flavour intensity (Ruusunen et al., 2005).

One way to fabricate meat and fish products with a better texture in spite of low salt, phosphate or protein content is to utilize enzymes that stabilize proteins by forming additional covalent cross-links. Currently, transglutaminases (TG, glutaminylpeptide:amine γ-glutamyltransferase, EC 2.3.2.13) are the only intensively studied and commercially available enzymes for cross-linking of meat and fish proteins. TG has been reported to improve texture (Mugumura et al., 1999) and gelling (De Backer-Royer et al., 1992) of meat systems. In cooked meat products, gel firmness and water-holding capacity (WHC) have been reported to increase by TG in high-salt (2%) products but not in low-salt products (Pietrasik and Li-Chan, 2002a). In a low-salt (1%) systern TG was able to improve consistency (firmness) of the product but not cooking loss (Dimitrakopoulou et al., 2005). TG has been reported to be used in gel strength enhancement of pork meat sausages (Mugumura et al., 1999), as a binder together with soy protein in low-sodium restructured pork meats (Tsao et al., 2002), as a binder together with soy and milk proteins in low-phosphate chicken sausage (Mugumura et al., 2003), and to improve yield and gel strength of low-salt chicken meat balls (Tseng et al., 2000). TG in combination with caseinate, KCl and dietary fiber has also been suggested to improve the texture of low-salt meat products (Jimenez-Colmenero et al., 2005; and Kuraishi et al., 1997). TG together with caseinate has been used as a cold set binder in pork, chicken and lamb meat batters (Carballo et al., in press) and with walnuts as a binder in fresh restructured beef steak (Serrano et al., 2004). TG used together with high pressure improved gel properties in low-fat chicken meat gels (Trespalacios and Pla, 2005) and together with K-carrageenan improved WHC of low-meat beef gels (Pietrasik and Li-Chan, 2002b).

Endogenous transglutaminase in fish (e.g. in rainbow trout, sardine, mackerels, read sea bream, ayu, bigeye snapper, carp, silver eel, Walleye pollock, white croker, scallop, shrimp, squid) is capable of protein crosslinking and is exploited e.g. in surimi production (An et al., 1996). It enhances gelation via crosslinking of muscle proteins of mackerel and hairtail (Hsieh et al., 2002). Added TG has been reported to be used in cold setting of striped mullet surimi production (Ramirez et al., 2000), in enhancing strength of kamaboko gels from Alaska pollock surimi (Seguro et al., 1995), in improving mechanical properties of arrow tooth flounder paste (Uresti et al., 2006) and improving gel forming abilities of horse mackerel together with chitosan (Gomez-Guillen et al., 2005). TG has also been used together with milk proteins to improve the mechanical properties of low-salt products from filleting waste from silver carp, whereby a slight increase in expressible water was observed (Uresti et al., 2004).

The increasing interest in the relationship between diet and health has lead to a growing demand for light products, which are low in salt, phosphate, and/or energy content. However, these light products are associated with undesired changes in texture, water-binding properties, flavour and shelf-life. Although transglutaminases have been shown to improve the texture of low-ingredient meat products, it is not satisfactory in all aspects e.g. with respect to water-binding properties. Therefore, there is still a need for healthy meat and fish products, which have an acceptable texture, stability, water-binding properties, appearance, palatability, taste, flavour, juiciness, processability, and overall acceptability. The present invention meets these needs.

The present invention is based on the use of tyrosinase to improve the properties of low-ingredient meat products. Tyrosinase has been reported to affect several food proteins, such as whey proteins (Thalmann and Loetz-beyer, 2002) and wheat proteins (Takasaki and Kawakishi, 1997; Takasaki et al., 2001). Lantto et al. (in press) have studied the effect of transglutamase, tyrosinase and freeze-dried apple pomace powder on gel forming and structure of homogenized pork meat. Tyrosinase was not able to affect gel forming in the experiments conducted, but it improved gel hardness of an unheated meat homogenate to a certain extent. The pork homogenate treated with the enzyme preparations contained conventional amounts of salt and phosphate.

DE 102 44 124 discloses aqueous media with increased viscosity containing polymers that have been modified with e.g. polyphenol oxidases. The viscous, aqueous media can easily be dried and rehydrated, and used to improve consistence, when added into food, or cosmetic or pharmaceutical products. Gels formed with tyrosinase functioned better than gels formed with laccase, when added into products of high protein or salt concentrations. The enzymes were used to crosslink the polymers of the aqueous media, not the food products as such.

### BRIEF DESCRIPTION OF THE INVENTION

The present invention provides a method of preparing a low-ingredient meat product, said method comprising comminuting meat, adding tyrosinase and optionally other ingredients to the comminuted meat to form a meat-containing mixture having a low content of at least salt, phosphate or meat, and incubating the mixture to form a meat product with modified texture or water-binding properties.

The invention further provides a low-ingredient meat product comprising additional tyrosinase, and having a low content of at least salt, phosphate or meat.

The invention still further provides the use of tyrosinase in modifying the texture or water-binding properties of a low-ingredient meat product having a low content of at least salt, phosphate or meat.

Specific embodiments of the invention are set forth in the dependent claims.

Other objects, details and advantages of the present invention will become apparent from the following drawings, detailed description and examples.

### BRIEF DESCRIPTION OF THE DRAWINGS

FIG. 1 shows the storage modulus (G′) of chicken breast myofibrils measured at (a) 25° C. and (b) 40° C. The treatment conditions were 4% protein, 50 mM Na-phosphate buffer, pH 6, 0.35 M NaCl, treatment time 3 h.

FIG. 2 shows firmness of unheated rainbow trout homogenate gels measured as maximum compression force. Homogenate samples were treated with 0, 20, 40, 80 or 160 nkat tyrosinase/g of protein and treated at a) 40° C., for 30 min, 1 h and 4 h; and b) at 4° C., 20 h.

FIG. 3 shows the effect of tyrosinase and transglutamase (TG) on the firmness of heated chicken breast meat homogenate gels measured as maximum compression force. The homogenate samples were low in meat content (65%), phosphate free (no added phosphate), or low in salt content (1% NaCl).

FIG. 4 shows the effect of tyrosinase and transglutaminase (TG) on the water-holding capacity (WHC) of heated chicken breast meat homogenate gels measured as weight loss. The homogenate samples were low in meat content (65%), phosphate free (no added phosphate), or low in salt content (1% NaCl).

FIG. 5 shows the results of controls without tyrosinase, and without transglutaminase (TG), respectively, on the firmness of heated chicken breast meat homogenate gels measured as maximum compression force. The Control contained 75% meat, 0.34% trisodiumpyrophosphate and 2% salt (NaCl). NOPP contained no added phosphate; LM contained a reduced amount of meat (65%); and LS contained a reduced amount of salt (1%).

FIG. 6 shows the results of controls without tyrosinase, and without transglutaminase (TG), respectively, on the water-holding capacity (WHC) of heated chicken breast meat homogenate gels measured as weight loss. The Control contained 75% meat, 0.34% trisodiumpyrophosphate and 2% salt (NaCl). NOPP contained no added phosphate; LM contained a reduced amount of meat (65%); and LS contained a reduced amount of salt (1%).

### DETAILED DESCRIPTION OF THE INVENTION

Consumers demand high quality and healthy meat products at feasible prices, which leads to a need for meat products with lower amounts of ingredients such as salts, meat and fat. Salt (NaCl) affects texture, water holding, flavour and microbial stability. Phosphates are used in meat processing to promote water-binding and to reduce cooking loss when NaCl-levels are low. Reduction of salt (NaCl), phosphate and/or meat inevitably leads to poor texture and water-holding of the products. Tyrosinase is an excellent protein crosslinking enzyme to improve both the above mentioned technological parameters, i.e. texture and water binding in processed meat products, as well as to bind meat pieces together in fresh meat products.

Tyrosinase belongs to the group of phenol oxidases, which use oxygen as electron acceptor. Traditionally tyrosinases can be distinguished from other phenol oxidases, i.e. laccases, on the basis of substrate specificity and sensitivity to inhibitors. However, the differentiation is nowadays based on structural features. Structurally the major difference between tyrosinases and laccases is that tyrosinase has a binuclear copper site with two type III coppers in its active site, while laccase has altogether four copper atoms (type I and II coppers, and a pair of type III coppers) in the active site.

Tyrosinase oxidizes various phenolic compounds to the corresponding quinones. The quinones are highly reactive and may react further nonenzymatically. A typical substrate of tyrosinase is tyrosine (or tyrosine residue in proteins), which is first hydroxylated into DOPA (dihydroxyphenylalanine or DOPA residue in proteins)), which is then further oxidized by the enzyme to dopaquinone (or dopaquinone residue in proteins). Dopaquinone may react non-enzymatically with a number of chemical structures, such as other dopaquinones, thiol and amino groups. Tyrosinase thus has two enzyme activities in one and the same protein, i.e. monophenol monooxyganase activity (EC 1.14.18.1) and catechol oxidase activity (EC 1.10.3.1) as shown below.

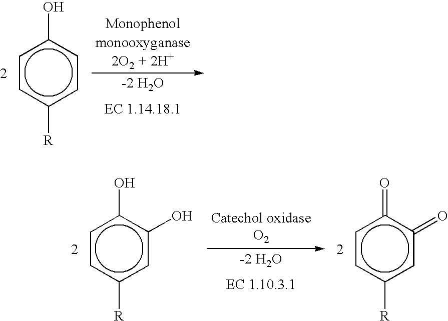

The substrate specificity of tyrosinase is relatively broad, and the enzyme is capable of oxidizing a number of polyphenoles and aromatic amines. Contrary to laccase (EC 1.10.3.2), however, tyrosinase does not oxidize syringaldazin. At least tyrosine, lysine and cysteine residues in proteins form covalent bonds with active dopaquinones catalysed by tyrosinase.

Tyrosinase activity can be measured by techniques generally known in the art. L-DOPA or L-tyrosine can be used as a substrate, whereafter dopachrome formation may be monitored spectrofotometrically, or alternatively substrate consumption may be monitored by following the oxygen consumption.

Tyrosinases are widely distributed in nature, and they are found in animals, plants, fungi and bacteria. Especially vegetables and fruits susceptible of browning are rich in tyrosinase. The only commercially available tyrosinase at present is derived from the mushroom Agaricus bisporus. The tyrosinase used in the present invention may originate from any animal, plant, fungus or microbe capable of producing tyrosinase. According to one embodiment of the invention, the tyrosinase is derived from a filamentous fungus. It may for example be an extracellular tyrosinase obtainable from Trichoderma reesei (WO 2006/084953).

The low-ingredient meat product is prepared by comminuting the meat, adding an effective amount of tyrosinase and optionally other ingredients, and incubating the meat-containing mixture obtained under conditions suitable for modifying the texture and/or water-binding properties thereof. “Low-ingredient” as used herein refers to a product having a reduced content of at least one of the ingredients selected from the group consisting of salt, phosphate and meat. The low-ingredient product may have a low content of more than one ingredient, e.g. a low content of both salt and phosphate, or even a low content of all three salt, phosphate and meat.

Normally, about 2 wt-% sodium chloride (NaCl) is added to conventionally salted meat products. According to the invention, a low-ingredient meat product may comprise less than 2.0 wt-% of salt, preferably less than 1.5 wt-%. Meat products comprising no more than 1.2 wt-% salt are generally considered as low-salt products. The meat product of the invention therefore preferably contains no more than 1.2 wt-% salt, and, according to one embodiment of the invention, no more than 1.0 wt-%. “Salt” as used herein in singular refers to NaCl.

The addition of phosphates has increased during the last years, because phosphates may be used to maintain the structure and water-binding ability of low-salt products. Nowadays industry normally adds 0.2 wt-% phosphate (measured as P₂O₅) to a meat product, which corresponds to 0.34 wt-% trisodiumpyrophosphate. The low-ingredient meat product of the present invention may contain less than 0.2 wt-% phosphate, preferably it contains no more than 0.1 wt-% added phosphate (measured as P₂O₅). Most preferably the low-ingredient meat product is phosphate-free, i.e. no phosphate has been added.

The low-ingredient product of the invention may have a low meat content, which means that it contains no more than 68 wt-% of meat, and more preferably no more than 65 wt-%. In order to obtain a low-energy product, the water content may correspondingly be increased. Naturally the energy content of the meat product also depends on the fat content thereof. However, fat reduction may cause technological and sensory problems. The use of tyrosinase for cross-linking the meat proteins enhances the use of lean meat, and diminishes the need for additional fat. Accordingly, the meat product prepared may be a fat-reduced product containing 15-18 wt-% fat, or a low-fat meat product containing up to 10 wt-% fat, or a lean meat product containing up to 5 wt-% fat. Preferably the fat content of the meat product is no more than 18 wt-%, preferably no more than 10 wt-%, and most preferably no more than 5 wt-% or even no more than 3 wt-%.

“Meat” as used herein includes any kind of meat of livestock, game, poultry, fish and other edible sea animals. The meat may be e.g. pork, beef, mutton, chicken, turkey, fish, molluscs and shellfish etc. “Meat product” refers to any material comprising meat or meat protein as an essential ingredient, such as sausages, hams, restructured meat products, surimi, etc. Conveniently the meat product contains at least 20, 30, 40 or especially 45 wt-% meat. Cooked sausages usually contain at least 45 wt-% meat, whereas fermented sausages such as salami contain at least 90-95 wt-% meat. A restructured meat product may in practice comprise up to 100 wt-% meat. The particle size of the comminuted meat depends on the type of meat product to be prepared. For the manufacture of restructured meat products, the meat is cut into recognizable pieces with edges of usually several cm, whereas the meat in hams and sausages is usually ground, chopped and/or minced or otherwise homogenized. Typically ham contains coarsely ground meat with particles of several mm up to one or a few cm, whereas sausages contain finely ground meat.

The “meat-containing mixture” prepared comprises at least comminuted meat and tyrosinase. In addition, it may comprise “other ingredients” which encompass any conventional additives, such as NaCl, phosphates, and/or water. Further, the term other ingredients includes e.g. salts other than NaCl and phosphates, spices, preservatives, antioxidants, stabilizers, sugar, sweeteners, gums, binders, extenders, starch, dextrin-type of carbohydrates, animal or vegetable fats and oils, fat substitutes and/or other non-meat ingredients such as soy, casein, and whey, wheat proteins and other non-meat proteins etc. A restructured meat product is prepared by binding fresh meat pieces together with tyrosinase. No other ingredients are necessary, whereas sausages and hams are made of mixtures containing additional ingredients.

One embodiment of the invention comprises grinding the meat, adding tyrosinase and other ingredients to the ground meat to form a meat-containing mixture, incubating the mixture under conditions sufficient to modify the texture or water-binding properties, and stuffing the modified meat mixture into casings, and optionally heating or smoking the cased mixture.

In a typical sausage process, the meat is ground and chopped into a batter. Water, salt and other ingredients are added during chopping or to the batter. Tyrosinase is added to the meat mixture after grinding the meat but before, during or after the chopping of the ground meat. After incubation, the batter is stuffed into casings, and cooked and/or smoked. In a typical ham process, a brine containing salt, phosphate and other ingredients is added to ground meat, the meat mass in tumbled, and the tumbled meat mass is stuffed into casings and smoked and/or cooked and cooled. Tyrosinase is added prior to, during or after tumbling.

A restructured meat product is typically prepared of meat trimmed of fat and connective tissue and cut into pieces. Tyrosinase is mixed with the meat pieces and the mixture is incubated in a cooler. Salt or other ingredients may be added, but are not necessary. The mixture is then reshaped and stored in a refrigerator or freezer.

Tyrosinase is dissolved in an aqueous solution. An amount of at least 20, 40, 80, 160, 320 or 640 nkat/g meat protein is usually sufficient to modify the texture and/or water-binding properties of the meat-containing mixture. Tyrosinase is normally allowed to react at a temperature of about 4-40° C. for at least 10 minutes up to 24 hours or more. Naturally incubation at low temperatures requires longer incubation times and vice versa. An incubation time of at least 1 hour up to at least 18 h is convenient at 4° C., whereas reaction times of at least 10 minutes up to 4 hours at 40° C. are efficient.

Incubation of the meat-containing mixtures in the presence of tyrosinase improves the texture and/or water-binding properties of the final product. After incubation, the meat mixture may be shaped into a product that is easy to handle, to cut into slices etc., and that has a desirable appearance and flavour. The product may be marketed fresh or as a heat-treated product. In other words, tyrosinase can be used in the manufacture of processed low-ingredient meat products, such as in sausages and hams, as well as in restructured fresh meat products such as palatable steaks from e.g. low-value meat cuts. The texture and water binding of sausages are essential technological factors that influence product palatability and consumer acceptance.

The effect of tyrosinase on meat protein can be seen e.g. as polymerization of myofibril proteins. The texture modifying effect of tyrosinase can be seen e.g. as an increase in the storage modulus (G′) of myofibril or meat homogenate gels. The texture modifying effect of tyrosinase can also be seen e.g. as an improved firmness of meat product gels. Further, tyrosinase improves the water-binding properties of a meat product, which can also be seen as an increased water-holding capacity (WHC) of the meat product, which means less drip loss during storage in vacuum package, or less cooking loss and improved juiciness. This is contrary to the results obtained with transglutaminase.

The invention is illustrated by the following non-limiting examples. It should be understood, however, that the embodiments given in the description above and in the examples are for illustrative purposes only, and that various changes and modifications are possible within the scope of the invention.

### EXAMPLE 1

### Tyrosinase-Catalyzed Crosslinking of Myofibril Proteins Isolated from Chicken Breast Muscle

Changes in the molecular weight and mobility of the isolated salt soluble proteins (SSPs) of chicken breast myofibrils caused by Trichoderma reesei tyrosinase were analysed by sodium dodecylsulphate-polyacrylamide gel electrophoresis (SDS-PAGE). SSPs were isolated according to Xiong and Brekke (1989). SSPs were suspended in 50 mM Na-phosphate buffer, pH 6, containing 0.6 M NaCl to the protein concentration of 3 mg/ml. 60, 120 and 240 nkat of tyrosinase was added per g of protein. The reaction mixtures were incubated at 40° C. Samples were drawn at time points of 5 min, 1 hour, 3 hours and 18 hours. The major changes in protein bands on SDS-PAGE catalysed by tyrosinase were tentatively identified. Tyrosinase caused the following detectable electrophoretic changes: 1) appearance of large molecular protein below the well, 2) disappearance of myosin heavy chain, and 3) disappearance of troponin T band, and 4) disappearance of a myosin light chain. The results show that tyrosinase was capable of catalysing crosslinks formation in/between proteins isolated from chicken breast meat.

### EXAMPLE 2

### Tyrosinase-Catalyzed Crosslinking of Myofibril Proteins Isolated from a Rainbow Trout Fillet

Changes in the molecular weight and mobility of the isolated myofibril proteins of rainbow trout fillet caused by T. reesei tyrosinase were analysed by SDS-PAGE. Myofibril proteins were isolated essentially in the same way as the chicken breast myofibrils in Example 1. Isolated myofibrils were suspended in water containing 8% of sucrose in order to keep the proteins in solution pH of the suspension was not adjusted. First myofibril proteins (3 mg/ml) were treated with different amounts of tyrosinase in order to evaluate the crosslinking efficiency of the enzyme. 20, 40, 80, 160, 320 and 640 nkat tyrosinase was added per g of protein. The reaction mixtures were incubated at 40° C. for 2 hours, after which samples of the reaction mixtures were run to SDS-PAGE.

According to the SDS-PAGE results, tyrosinase dosages of 160 and 640 nkat/g were chosen for further studies. Next the efficiency of tyrosinase to crosslink rainbow trout myofibril proteins in different treatment conditions was investigated. The proteins were treated at 40° C. for 30 min, 1 hour and 4 hours and at 4° C. for 24 hours. Crosslinking efficiency was evaluated on SDS-PAGE.

The major changes in proteins caused by tyrosinase were tentatively identified. Tyrosinase caused the following detectable electrophoretic changes: 1) appearance of large molecular protein below the well, 2) disappearance of myosin heavy chain, and 3) disappearance of troponin T band. The results showed that tyrosinase was capable of catalysing crosslinks formation in/between proteins isolated from rainbow trout fillet.

### EXAMPLE 3

### Improvement of Gel Forming of Chicken Myofibrils by Tyrosinase

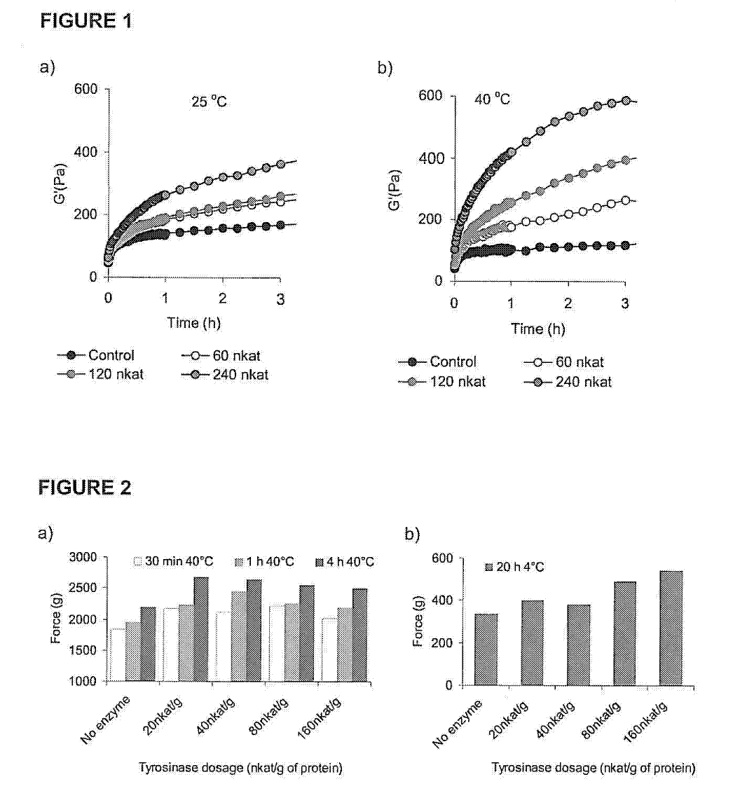

Ability of tyrosinase to form crosslinks in a 4% chicken myofibril suspension was investigated as a development of storage modulus (G′) measuring gel-forming improvement by tyrosinase at low deformation. Measurements were carried out during heating at 25° C. and 40° C. using a Bohlin VOR rheometer (Bohlin Reologi, Lund, Sweden) (FIG. 1). Chicken breast myofibrils were isolated according to Xiong and Brekke (1989) omitting EDTA and NaN₃ from the isolation buffer Isolated myofibrils were suspended to the protein concentration of 4% in 50 mM Na-phosphate buffer −0.35 M NaCl, pH 6. Samples of the myofibril suspension were treated with 0, 30, 60, 120 and 240 nkat of T. reesei tyrosinase/g of protein at 25° C. and 40° C. for 3 hours. The results show a greater increase in G′ in tyrosinase treated myofibril suspensions than in those treated only in buffer. Furthermore, increase of the treatment temperature intensified gel forming. Thus cross-links were formed in the chicken breast myofibril matrix by tyrosinase.

### EXAMPLE 4

### Improvement of Firmness of Rainbow Trout Homogenate Gels by Tyrosinase

To demonstrate that tyrosinase-catalysed cross-linking had a positive textural effect on rainbow trout protein gels, a homogenate prepared of 90% of rainbow trout fillet, 10% of water and 1.8% of salt (NaCl) was treated with tyrosinase (0, 20, 40, 80 and 160 nkat/g of protein) in different treatment conditions (FIG. 2). After the tyrosinase addition homogenate samples were allowed to stand at 4° C. for 10 min, after which the samples were incubated at 40° C. for 30 min, 1 h or 4 h and at 4° C. for 20 h. After the treatment, the samples were tempered to room temperature and measured for gel firmness with a texture Analyzer (TA-XTA, Stable Micro Systems, Surrey, Great Britain). The results indicate that tyrosinase was capable of increasing firmness of unheated rainbow trout homogenate gels.

### EXAMPLE 5

### Improvement of Firmness of Chicken Breast Meat Homogenate Gels by Tyrosinase

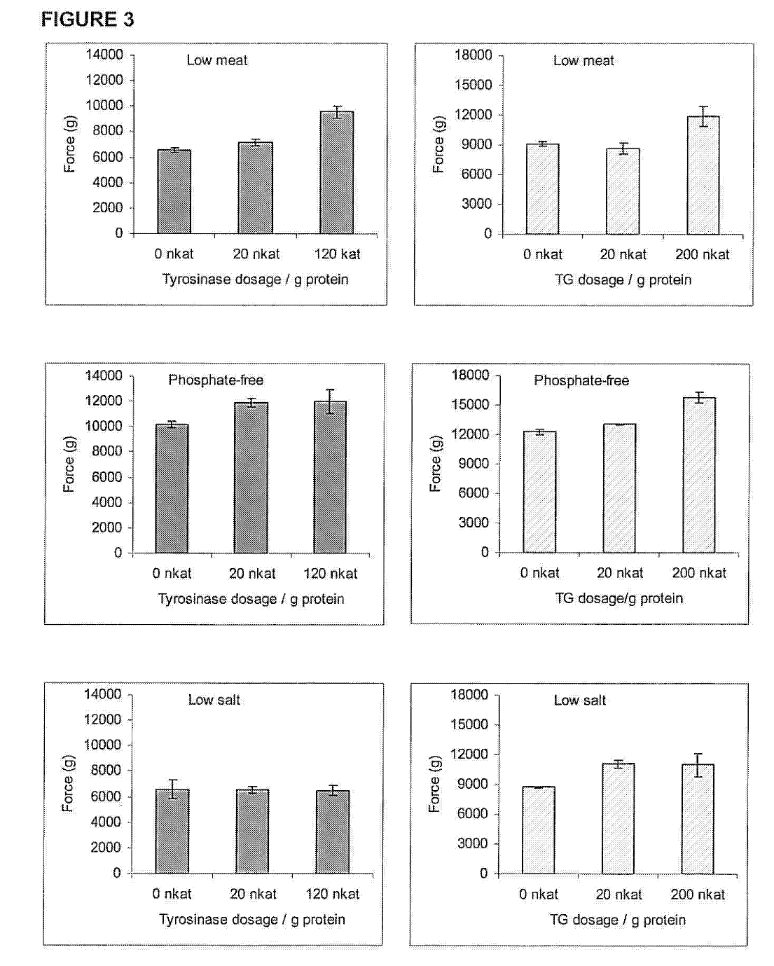

Chicken breast meat homogenate mixtures in oxygenated water were prepared of chicken breast meat trimmed free of visible fat containing different amounts of meat (65% or 75%), trisodiumpyrophosphate (0% or 0.34%), or salt (1% or 2%) in the presence of T. reesei tyrosinase (0 nkat, 20 nkat or 120 nkat/g protein). Only one ingredient was reduced at the time, the other two ingredients being unreduced. Immediately after the tyrosinase addition, the meat homogenate samples (tyrosinase treated and control samples) were stuffed into cylindrical steel tubes (diameter 30 mm, height 45 mm) and allowed to stand at 4° C. for 1 hour, after which they were removed to a water bath of 40° C. After the internal temperature of the samples had reached 40° C., which took about 10 minutes, the samples were incubated at 40° C. for 1 hour. The samples were moved to a water bath of 77° 0. After 10 minutes, the internal temperature of the samples was 72° C. and the samples were moved to a water bath of 25° C. for 30 minutes, after which the internal temperature had declined to 25° C. After tempering to 25° C., the samples were immediately measured for gel firmness. The results are shown in FIG. 3, left column. Tyrosinase increased gel firmness of a low-meat homogenate (meat content reduced from 75% to 65%). Furthermore, the results show that tyrosinase was capable of increasing gel firmness in a homogenate free of added phosphate (phosphate amount reduced from 0.34% to 0%). Tyrosinase had only a very limited effect on the gel firmness of the low-salt homogenate at the doses tested.

For comparison, a similar kind of procedure was carried out with transglutaminase with the dosages of 0, 20 or 200 nkat/g protein. Unlike with tyrosinase, the added water was not oxygenized. The results are shown in FIG. 3, right column. The absolute effect obtained with tyrosinase and transglutaminase, respectively, are not comparable, because the tests were performed on different occasions and on material that had been stored for different times. Further, the enzyme activities of tyrosinase and TG, respectively, cannot be compared either, because the two enzymes have completely different reaction mechanisms, and therefore their activity (nkat/g protein) is determined using different model substrates. Anyway, it can be seen from FIG. 3 that tyrosinasecatalysed crosslink formation had a positive effect on gel firmness, and that this effect was similar to that of TG.

Tyrosinase activity was assayed using 15 mM L-DOPA (Sigma, USA) as substrate at pH 7 and room temperature according to Robb (1984). TG activity was determined using 0.2 M N-carbobenzoxy (CBZ)-L-glutaminyl-glysine (Sigma, USA) as the substrate at pH 6 (Folk, 1970). Enzyme activity is expressed in nanokatals (nkat). One nkat is defined as the amount of enzyme activity that converts one nmol per second of substrate used in the assay conditions. Enzyme dosage nkat/g protein means the amount of enzyme calculated as activity and dosed per one gram of meat protein.

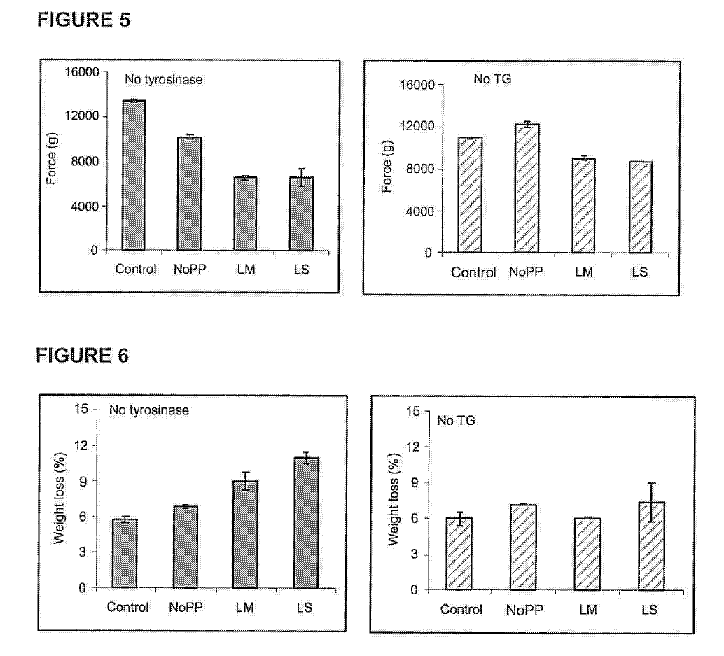

Controls without enzymes were also conducted, wherein one control consisted of a meat homogenate comprising 75% meat, 2% salt and 0.34% trisodiumpyrophosphate. A phosphate-free control (NOPP) contained 75% meat, 2% salt, and 0% trisodiumphosphate; a low-meat control (LM) contained 65% meat, 2% salt, and 0.34% trisodiumpyrophosphate; and a low-salt control (LS) contained 75% meat, 1% salt, and 0.34% trisodiumpyrophosphate. The results are shown in FIG. 5. The left column shows the no-enzyme controls in the tyrosinase experiments, and the right column the no-enzyme controls in the TG experiments. It can be seen that reduction of any of meat, salt and phosphate leads to a decrease in gel firmness.

### EXAMPLE 6

### Improvement of Water-Holding Capacity (WHC) of Chicken Breast Homogenate Gels by Tyrosinase

Chicken meat homogenate mixtures were prepared of chicken breast meat trimmed free of visible fat containing different amount of protein (65% or 75%), salt (1% or 2%) and trisodiumpyrophosphate (0% or 0.34%) in the presence of T. reesei tyrosinase (0 nkat, 20 nkat or 120 nkat/g protein). Only one ingredient was reduced at the times, the other ingredients being unreduced. The homogenate samples were treated as explained in Example 5 and measured for weight loss. Weightloss of the meat homogenate samples was determined after heating the samples to the core temperature of 72° C. and subsequent cooling to 25° C. by the ‘net test’ according to Hermansson and Lucisano (1982). The samples were centrifuged at 20° C. for 10 minutes at 490×g (Biofuge Stratos, rotor no. 3047, Heraeus Instruments, USA). The amount of released liquid was determined by weighing after centrifugation. Weight loss was calculated from the formula:

Weight loss (%)=(weight of liquid phase/weight of sample)×100

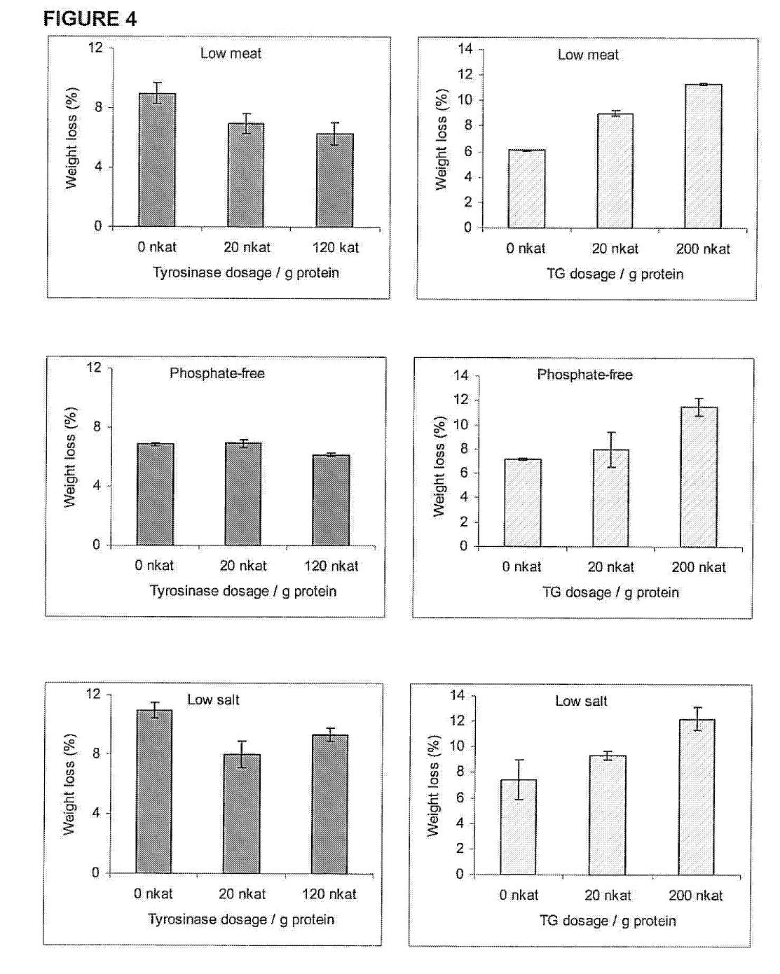

The results are shown in FIG. 4, left column. It can be seen that tyrosinase decreased weight loss, i.e. increased WHC in a low-meat system (meat content reduced from 75% to 65%) and low salt system (salt content decreased from 2% to 1% NaCl) Furthermore, the results show that tyrosinase was capable of maintaining WHC on the control level in a chicken meat homogenate free of added phosphate, i.e. phosphate amount decreased from 0.34% to 0%.

For comparison, a similar procedure was carried out with transgiutaminase (0, 20 or 200 nkat/g protein) instead of tyrosinase. The results are shown in FIG. 4, right column. The absolute effect obtained with tyrosinase and transglutaminase, respectively, are not comparable, because the tests were performed on different occasions and of material that had been stored for different times. Further, the enzyme activities of tyrosinase and TG, respectively cannot either be compared, because the two enzymes have completely different reaction mechanisms, and their activity (nkat/g protein) is determined using different model substrates. Anyway it can be seen from FIG. 4 that contrary to TG, tyrosinase treatment affects water-holding positively. Tyrosinase decreased weight loss in the low-meat and low-salt homogenates and maintained WHC in the phosphate-free homogenate, whereas TG had the opposite effect, i.e. it increased the weight loss in all three cases.

Controls without enzymes were also conducted, wherein one control consisted of a meat homogenate comprising 75% meat, 2% salt, and 0.34% trisodiumpyrophosphate. A phosphate-free control (NOPP) contained 75% meat, 2% salt and 0% trisodiumpyrophosphate; a low-meat control (LM) contained 65% meat, 2% salt and 0.34% trisodiumpyrophosphate; and a low-salt control (LS) contained 75% meat, 1% salt and 0.34% trisodiumpyrophosphate. The results are shown in FIG. 6. The left column shows the no-enzyme controls in the tyrosinase experiments, and the right column the no-enzyme controls in the TG experiments. It can be seen that reduction of any of meat, salt and phosphate leads to an increased weight loss.

### REFERENCES

An, H., Peters, M. Y., and Seymour, T. A. 1996. Roles of endogenous enzymes in surimi gelation. Trends Food Sci. Technol. 7, 321-327.
Carballo, J., Ayo, J, and Jiménez Colmenero, F. Microbial transglutaminase and caseinate as cold set binders: Influence of meat species and chilling storage. LWT/Food Sci. Technol. (in press)
De Backer-Royer, C., Traoré, F., and Meunier, J. C. 1992. Polymerization of meat and soybean proteins by human placental calcium-activated factor XIII. J. Agric. Food Chem. 40, 2052-2056.
Dimitrakopoulou, M. A., Ambrosiadis, J. A., Zetou, F. K., and Bloukas, J. G. 2005. Effect of salt and transglutaminase (TG) level and processing conditions on quality characteristics of phosphate-free, cooked, restructured pork shoulder. Meat Sci. 70, 743-749.
Folk, J. E. 1970. Transglutaminase (guinea pig liver). Methods Enzymol. 17A, 889-894
Gómez-Guillén, M. C., Montero, P., Solas, M. T., and Pérez-Mateos, M. 2005. Effect of chitosan and microbial transglutaminase on the gel forming ability of horse mackerel (Trachurus spp.) muscle under high pressure. Food Rres. Int. 38, 103-110.
Hermansson, A. M., and Lucisano, M. 1982. Gel characteristics—Waterbinding properties of blood plasma gels and methodological aspects on the waterbinding of gel systems. J. Food Sci. 47, 1955-1964.
Hsieh, J. F., Tsai, G. J., and Jiang, S. T. 2002. Microbial transglutaminase and recombinant cystatin affects on improving the quality of mackerel surimi. J. Food Sci. 67, 3120-3125.
Jiménez Colmenero, F. 1996. Technologies for developing low-fat meat products. Trends Food Sci. Technol. 7, 41-48.
Jiménez-Colmenero, F., Carballo, J., and Cofrades, S. 2001. Healthier meat and meat products: their role as functional foods. Review. Meat Sci. 59, 5-13.
Jiménez Colmenero, F., Ayo, M. J., and Carballo, J. 2005. Physicochemical properties of low sodium frankfurter with added walnut: effect of transglutaminase combined with caseinate, KCl and dietary fibre as salt replacers. Meat Sci. 69, 781-788.
Kuraishi, C., Sakamoto, J., Yamazaki, K., Susa, Y., Kuhara, C, and Soeda, T. 1997. Production of restructured meat using microbial transglutaminase without salt or cooking. J. Food Sci. 62, 488-490, 515.
Lantto, R., Plathin, P., Niemistö, M., Buchert, J., and Autio, K. Effects of transglutaminase, tyrosinase and freeze-dried apple pomace powder on gel forming and structure of pork meat. LWT/Food Sci. Technol. (in press).
Mugumura, M., Tsuruoka, K., Fujino, H., Kawahara, S., Yamauchi, K., Matsumura, S., and Soeda, T. 1999. Gel strength enhancement of sausages by treating with microbial transglutaminase. In Proc. 45^{th} Int. Congr. Meat Sci. Technol. 1999; Yokohama, Japan, Vol. 1., pp. 138-139.
Mugumura, M., Tsuruoka, K., Katayama, K., Erwanto, Y., Kawahara, S., Yamauchi, K., Sathe, S. K., and Soeda, T. 2003. Soybean and milk proteins modified by transglutaminase improves chicken sausage texture even at reduced levels of phosphate. Meat Sci. 63, 191-197.
Pietrasik, Z., and Li-Chan, E. C. Y. 2002a. Response surface methodology study on the effects of salt, microbial transglutaminase and heating temperature on pork batter gel properties. Food Res. Int., 35, 387-396.
Pietrasik, Z., and Li-Chan, E. C. Y. 2002b. Binding and textural properties of beef gels as affected by protein, κ-carrageenan and microbial trans-glutaminase addition. Food Res. Int. 35, 91-98.
Ramirez, J. A., Rodríguez-Sosa, Morales, O. G., and Vázquez, M. 2000. Surimi gels from striped mullet (Mugil cephalus) employing microbial transglutaminase. Food Chem., 70, 443-449.
Robb, D. A. 1984. Tyrosinase, In: R. Lontie (Ed.) Copper proteins and copper enzymes, Vol. 2, pp. 207-240. Boca Raton, Fla., USA, CRC Press Inc.
Ruusunen, M, Vainionpää, J., Lyly, M., Lähteenmäki, L., Niemistö, M., Ahvenainen, R., and Puolanne, E. 2005. Reducing the sodium content in meat products: The effect of the formulation in low-sodium ground meat patties. Meat Sci. 69, 53-60.
Seguro, K., Kumazawa, Y., Ohtsuka, T., Toiguchi, S, and Motoki, M. 1995. Microbial transglutaminase and ε-(γ-glutamyl) lysine cross-link effects on elastic properties of kamaboko gels. J. Food Sci. 60, 305-311.
Serrano, A., Cofrades, S., and Jiménez Colmenero, F. 2004. Trans-glutaminase as binding agent in fresh restructured beef steak with added walnuts. Food Chem. 85, 423-429.
Takasaki, S., and Kawakishi, S. 1997. Formation of protein-bound 3,4-dihydroxyphenylaIanine and 5-S-cysteinyl-3,4-dihydroxyphenylalanine as new cross-linkers in gluten. J. Agric. Food Chem. 45, 3472-3475.
Takasaki, S., Kawakishi, S., Murata, M., and Homma, S. 2001. Polymerisation of gliadin mediated by mushroom tyrosinase. Lebensmittel-Wissenschaft und—Technologie, 34, 507-512.
Thalmann, C. R., and Lötzbeyer, T. 2002. Enzymatic cross-linking of proteins with tyrosinase. Eur. Food Res. Technol. 214, 276-281.
Trespalacios, P., and Pla, R. 2005. Simultaneous application of transglutaminase and high pressure to improve functional properties of chicken meat gels. Food Chem. (in press).
Tsao, C. Y., Kao, Y. C., Hsieh, J. F., and Jiang, S. T. 2002. Use of soy protein and microbial transglutaminase as a binder in low-sodium restructured meats. J. Food Sci. 76, 3502-3506.
Tseng, T. F., Liu, D. C., and Chen, M. T. 2000. Evaluation of transglutaminase on the quality of low-salt chicken meat-balls. Meat Sci., 55, 427-431.
Uresti, R. M., Téllez-Luis, S. J., Ramírez, J. A., and Vázquez, M. 2004. Use of dairy proteins and microbial transglutaminase to obtain low-salt fish products from filleting waste from silver carp (Hypophthalmichtys molitrix). Food Chem. 86, 257-262.
Uresti, R. M., Velazquez, G., Vázquez, M., Ramírez, J. A., and Torres, J. A. 2006. Effects of combining microbial transglutaminase and high pressure processing treatments on the mechanical properties of heat-induced gels prepared from arrowtooth flounder (Atheresthes stomias). Food Chem. 94, 202-209.
Xiong, Y. L. and Brekke, C. J. 1989. Changes in protein solubility and gelation properties of chicken myofibrils during storage. J. Food Sci. 54, 1141-1146.

1. Method of preparing a low-ingredient meat product, said method comprising comminuting meat, adding tyrosinase and optionally other ingredients to the comminuted meat to form a meat-containing mixture having a low content of at least salt, phosphate or meat, and incubating the mixture to form a meat product with modified texture or water-binding properties.

2. The method of claim 1, comprising adding tyrosinase to meat of livestock, game, poultry, fish, molluscs or shellfish.

3. The method of claim 1, comprising preparing low-ingredient sausage or ham.

4. The method of claim 1, comprising grinding the meat, adding tyrosinase and other ingredients to the ground meat to form a meat-containing mixture, incubating the mixture under conditions sufficient to modify the texture or water-binding properties, and stuffing the modified meat mixture into casings, and optionally heating or smoking the cased mixture.

5. The method of claim 1, comprising binding meat pieces together with tyrosinase to form a restructured fresh meat product.

6. The method of claim 1, comprising adding less than 2%, preferably no more than 1.2%, and more preferably no more than 1% salt.

7. The method of claim 1, comprising adding less than 0.2%, preferably no more than 0.1% phosphate, and most preferably without adding phosphate.

8. The method of claim 1, comprising preparing a meat product containing no more than 68% meat, preferably no more than 65% meat.

9. The method of claim 1, comprising preparing a meat product having a fat content of no more than 18%, preferably no more than 10%, and most preferably no more than 5%.

10. Low-ingredient meat product comprising additional tyrosinase, and having a low content of at Least salt, phosphate or meat.

11. The meat product of claim 10, which is sausage or ham.

12. The meat product of claim 10, which is a restructured fresh meat product.

13. The meat product of claim 10, wherein the salt content is less than 2%, preferably no more than 1.2%, and more preferably no more than 1%.

14. The meat product of claim 10 which contains less than 0.2%, preferably no more than 0.1% phosphate, and most preferably it contains no added phosphate.

15. The meat product of claim 10, which contains no more than 68% meat, preferably no more than 65% meat.

16. The meat product of claim 10 having a fat content of no more than 18%, preferably no more than 10%, and most preferably no more than 5%.

17. The meat product of claim 10, comprising meat of livestock, game, poultry, fish, molluscs or shellfish.

18. (canceled)

19. The method of claim 2, comprising grinding the meat, adding tyrosinase and other ingredients to the ground meat to form a meat-containing mixture, incubating the mixture under conditions sufficient to modify the texture or water-binding properties, and stuffing the modified meat mixture into casings, and optionally heating or smoking the cased mixture.

20. The meat product of claim 13, which contains less than 0.2%, preferably no more than 0.1% phosphate, and most preferably it contains no added phosphate.
